(19) United States
(12) Patent Application Publication
(10) Pub. No.: US 2025/0241503 A1
(43) Pub. Date: Jul. 31, 2025

(54) MULTI-LAYER MELAMINE SPONGE

(71) Applicant: Stephen Rindlisbacher, Pleasant Grove, UT (US)

(72) Inventor: Stephen Rindlisbacher, Pleasant Grove, UT (US)

(21) Appl. No.: 18/424,771

(22) Filed: Jan. 27, 2024

(51) Int. Cl. A47L 13/16; A47L 23/04; B32B 5/18; B32B 27/06; B32B 27/08; B32B 27/40; B32B 27/42

(52) U.S. Cl. CPC A47L 13/16; A47L 23/04; B32B 5/18; B32B 27/065; B32B 27/08; B32B 27/40; B32B 27/42; B32B 2250/03; B32B 2266/0285; B32B 2432/00

(57) ABSTRACT

According to an aspect of the present invention, there is provided melamine sponge, comprising: a first outer melamine layer; a middle scrubbing layer; and a second outer melamine layer separated from the first outer melamine layer by the middle scrubbing layer.

### BACKGROUND

Melamine sponges have been described numerous times in the prior art patent literature.

For example, U.S. Pat. No. 11,197,599 discloses a cleaning device for removing marks from a surface includes a body of melamine foam sponge having a front side and a rear side opposed to the front side, and a holding layer secured to the rear side of the body of melamine foam sponge to prevent relative movement therebetween. The holding layer is preferably a cloth and more preferably natural or synthetic chamois which can be used to wipe and/or buff the surface after rubbing the body of melamine foam sponge on the surface to remove at least one surface mark. The body of melamine foam sponge can be pre-moistened with a liquid such as a disinfecting solution.

U.S. Pat. No. 10,610,065 discloses a cleaning disk comprised of melamine foam. The cleaning disk may be attached to the distal end of the handle using, for example, Velcro, an adhesive, or a locking mechanism using snaps or slots. In some embodiments, the cleaning disk may have a backing plate fixedly attached to the pad on the side opposite the cleaning surface with the attachment means for the cleaning pad on or attached to the backing plate.

While melamine sponges are uniquely useful for removing stains and marks from hard surfaces, they are also delicate and lacking versatility. Accordingly, there is still a need in the art for improved melamine foam sponges.

### SUMMARY OF INVENTION

Therefore, the present invention provides a more rugged melamine sponge with a middle scrubbing layer positioned between two outer melamine layers.

According to an aspect of the present invention, there is provided melamine sponge, comprising: a first outer melamine layer; a middle scrubbing layer; and a second outer melamine layer separated from the first outer melamine layer by the middle scrubbing layer.

According to another aspect of the present invention, there is provided a method of using a melamine sponge, comprising: applying pressure to a first outer melamine layer to press a second outer melamine layer separated from the first outer melamine layer by a scrubbing layer against a surface; releasing the second outer melamine layer from the surface; and pressing the scrubbing layer against the surface.

### BRIEF DESCRIPTION OF THE DRAWINGS

FIG. 1 illustrates a perspective view of a multi-layer melamine sponge according to the present invention.

FIG. 2 illustrates an end of the multi-layer melamine sponge according to the present invention.

FIG. 3 illustrates a side view of the multi-layer melamine sponge according to the present invention.

### DETAILED DESCRIPTION

The present invention comprises a scrubbing layer sandwiched between outer melamine foam layers.

The scrubbing layer can be for example a urethane abrasive sponge layer made of polyurethane. In other embodiments, the scrubbing layer could also be made of polyester, nylon or vegetable cellulose, among other compositions.

The melamine foam is preferably an abradable melamine foam which disintegrates or wears away during use. Melamine foam can be for example Basotect®, a flexible, open-cell foam made from melamine resin. A typical characteristic is the intricate spatial mesh structure that is formed by thin ribs that can therefore be bent into shape easily. The melamine foam can be an open cell foam that is microporous and extremely hard so that when rubbed on a surface for cleaning it works like extremely fine sandpaper.

Other types of melamine foam can be used as well.

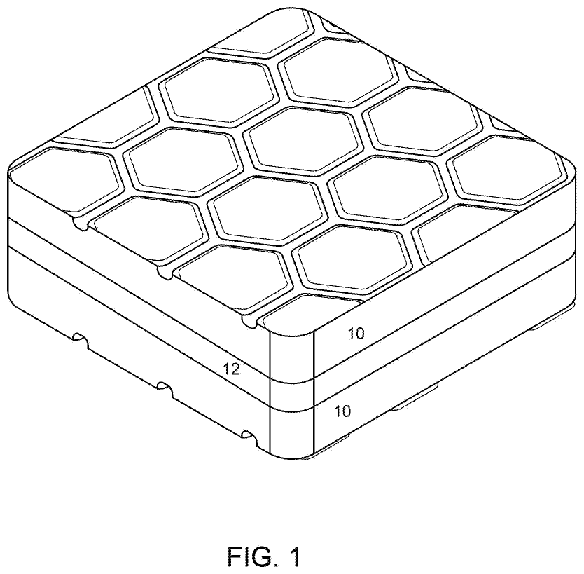

FIG. 1 illustrates a perspective view of a multi-layer melamine sponge according to the present invention.

The melamine sponge consists of outer melamine layers 10 and scrubbing layer 12, as described above. The outer melamine layers 10 may be identical, or one of the layers may be different from the other, for example, thicker.

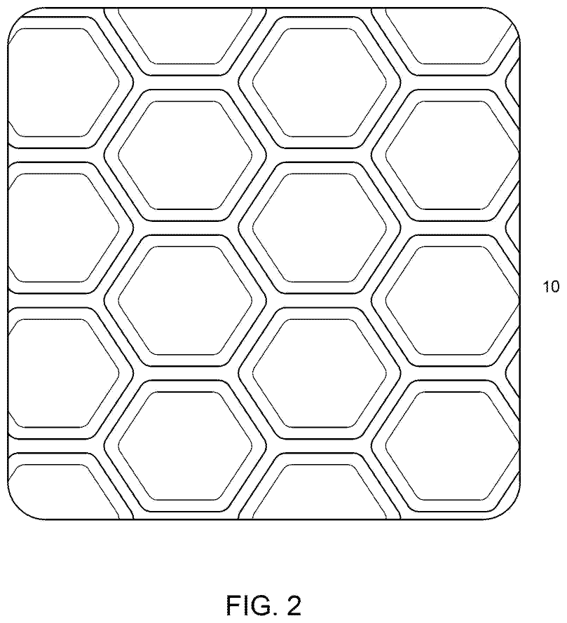

FIG. 2 illustrates an end of the multi-layer melamine sponge according to the present invention.

The outer melamine layer 10 has protrusions which are illustrated as being hexagonal shaped but any other suitable shape can alternatively be utilized.

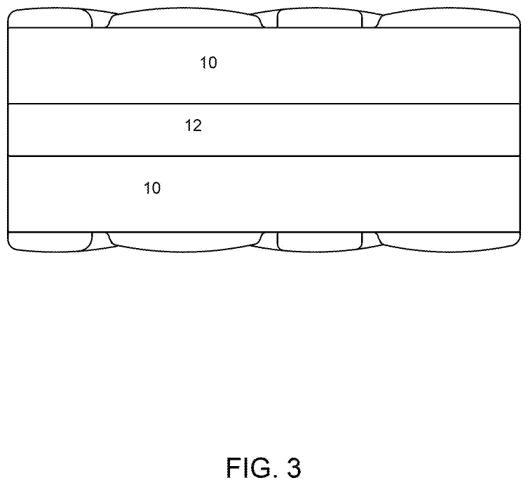

FIG. 3 illustrates a side view of the multi-layer melamine sponge according to the present invention.

Scrubbing layer 12 is exposed on the sides of the multi-layer melamine sponge between the melamine layers 10. Scrubbing layer 12 can be used to clean a surface by applying the side of the multi-layer melamine sponge to the surface.

Scrubbing layer 12 also improves the durability and toughness of cleaning by the top and bottom of the melamine sponge even when the scrubbing layer is not directly is use with the side of the melamine sponge against a surface.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A melamine sponge, comprising:
a first outer melamine layer;
a middle scrubbing layer; and
a second outer melamine layer separated from the first outer melamine layer by the middle scrubbing layer.

2. The melamine sponge of claim 1, wherein the first outer melamine layer and the second outer melamine layer are identical.

3. The melamine sponge of claim 1, wherein the melamine sponge is square in shape.

4. The melamine sponge of claim 1, wherein one or more of the melamine layers are abradable melamine foam.

5. The melamine sponge of claim 1, wherein the middle scrubbing layer is made of polyurethane.

6. A method of using a melamine sponge, comprising:
applying pressure to a first outer melamine layer to press a second outer melamine layer separated from the first outer melamine layer by a scrubbing layer against a surface;
releasing the second outer melamine layer from the surface; and
pressing the scrubbing layer against the surface.

7. The method of using a melamine sponge of claim 6, wherein the surface is a shoe.

8. The method of using a melamine sponge of claim 6, wherein the surface is a wall.

9. The method of using a melamine sponge of claim 6, wherein the surface is a floor.

10. The method of using a melamine sponge of claim 6, further comprising applying pressure to the second outer melamine layer to press the first outer melamine layer against a surface.
